(19) United States
(12) Patent Application Publication
(10) Pub. No.: US 2008/0084038 A1
(43) Pub. Date: Apr. 10, 2008

(54) Dumping cart

(76) Inventor: Dannie R. Byers, Landover, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/543,985

(22) Filed: Oct. 6, 2006

(51) Int. Cl. B62B 3/08

(52) U.S. Cl. 280/47.34

(57) ABSTRACT

A dumping cart has a carriage, a front wheel mounted to rotate on a horizontal axis with respect to the carriage and a pair of laterally spaced back wheels mounted to turn about horizontal axles supported on vertical pivots attached to the carriage. A tray is mounted on the carriage and has a front portion and a back portion, the tray being pivotal on a horizontal axis with respect to the carriage. A handle support extends up from the carriage and a handle attached to the handle support for pushing, pulling and steering the dumping cart. A pair of levers are pivoted to the handle support, the levers each having first and second ends, wherein the first ends of the levers provide handles for pivoting the levers relative to the handle support and the second ends have couplings thereon adjacent the rear portions of the tray. A linkage is attached to the couplings at the second ends of the levers to the rear portions of the tray to lift the tray upon pushing down on the first ends of the levers.

### FIELD OF THE INVENTION

Generally, the invention relates to carts capable of being manually manipulated by a person and manually dumped. More particularly, the invention relates to such carts that may be dumped utilizing downwardly applied pressure on the handle assembly.

### BACKGROUND OF THE INVENTION

As set forth in U.S. Pat. No. 6,886,838 issued in May 3, 2005, numerous types of carts exist that have a wheel or wheels, a pan, tray or bucket and a lever-handle assembly where the cart can be manually manipulated by a person and manually dumped. A classic example of such a cart is a wheelbarrow that typically has a single front wheel, opposing handles, which extend from the front wheel in a rearward direction and a pan, tray or bucket fixed on top of the lever-handles. Millions of such carts have been produced for use around the world. In use, a wheelbarrow typically rests on the ground at the front wheel and on support legs when not being manipulated by person. From this position the bucket of the wheelbarrow may be loaded. When the wheelbarrow is being moved from one position to another, the person grips handles distal from the front wheel to raise the handles and lifts the support legs off the ground. At this point the wheelbarrow is supported by the front wheel and the person holding on the handles. When dumping contents of the bucket is desired, without regard to whether the support legs are in contact with the ground or elevated above the ground for movement of the wheelbarrow, the person raises the handles to angularly tip the wheelbarrow. This is an awkward operation which can require substantial strength depending on the load. When dumping, the hands first move upward while lifting the handles up with a pulling action. Then a transfer occurs with a person's grip in which the handles shift and the person applies a pushing action upward on the handles. This operation is performed while balancing the weight of the wheelbarrow and the contents of the bucket between the opposing handles and on the single front wheel.

Various innovations have been made to wheelbarrow designs to make the above dumping operation more controllable. In a first class of inventions, the stability of the front wheel is increased by either providing for a wider wheel or providing laterally spaced adjacent wheels. In another class of innovations, a unique angular arrangement of at least a grip portion of the handles is provided. Still another class of innovations attempts to provide more controllable dumping by applying downward pressure to the handles while the support legs remain in contact with the ground during the entire dumping procedure. In these designs, leg supports are fixed relative to their respective front wheels, however it was necessary to have previously lifted one half of the load in order to have transported the load.

Various deficiencies exist with known designs for carts configured as wheelbarrows. As previously explained, various attempts have been made to provide more controllable dumping operations for wheelbarrows. These attempts have been less efficient than desired. Accordingly, there is a need for a cart design which provides dumping that is more easily, safely and comfortably performed.

### SUMMARY OF THE INVENTION

In view of the aforementioned considerations, a dumping cart is provided which comprises a carriage having at least one front wheel and a rear support for engaging the ground behind the front wheel. A frame is mounted one the carriage and a pan is pivoted on the frame at a location adjacent to the front wheel. A handle support extends upwardly from the carriage and a lever arrangement is pivoted to the handle support. The lever arrangement extends rearward of the pan and has a first end distal of the pan and a second end adjacent to the pan. A linkage is disposed between the second end of the lever arrangement and a rear portion of the pan, wherein rotation of the lever arrangement pivots the pan to dump the load foreword of the front wheel.

In another aspect of the dumping cart, the linkage between the lever arrangement and the pan comprises a flexible cable arrangement.

In another aspect of the dumping cart, the rear support comprises at least one wheel and the handle support includes a handle for pushing, pulling or steering the cart.

In another aspect of the dumping cart, the at least one rear wheel is mounted to the carriage by a vertical pivot.

In still another aspect of the dumping cart, there are two laterally spaced rear wheels, each of which is mounted to the carriage by a vertical pivot, and a single front wheel.

In still another aspect of the dumping cart, the lever arrangement comprises a pair of levers with each lever having a handle at a first end and with each lever having a coupling at a second end with the flexible cable arrangement being attached at opposite ends to the second ends of the levers.

In a more specific configuration of the dumping cart, the dumping cart comprises a carriage with a front wheel mounted to rotate about a horizontal axis with respect to the axis and a pair of laterally spaced back wheels mounted to rotate about horizontal axles supported by vertical pivots attached to the carriage. A pan is mounted on the carriage and has a front portion in the back portion, the pan being pivoted on a horizontal axis with respect to the carriage. A handle support extends up from the carriage and a handle is attached to the handle support for pushing, pulling and steering the dumping cart. A pair of levers are pivoted to the handle support, the levers each having first and second ends. The first ends of the levers provide handles for pivoting the levers relative to the handle support and the second ends have couplings thereon adjacent to the rear portion of the pan. A linkage is attached to the couplings at the second ends of the levers and to the rear portion of the pan to lift the pan up upon pushing down on the first ends of the levers.

In a further aspect of the more specific configuration of the dumping cart, the linkage is a flexible cable arrangement attached at opposite ends to the couplings on the second ends of the levers.

In still a further aspect of the more specific configuration of the dumping cart, a frame is disposed on the carriage and provides a pivotal mounting of the pan adjacent to the first end of the pan.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of a dumping cart configured in accordance with the principles of the present invention showing the cart being pushed;

FIG. 2 is a perspective view of the dumping cart of FIG. 1 showing a person applying downward pressure to lever handles to initiate dumping;

FIG. 3 is a rear perspective view showing a tray of the dumping cart being raised for dumping a load therefrom;

FIG. 4 is a perspective view similar to FIG. 2, but showing the load being dumped from the pan of the dumping cart, and

FIG. 5 is a side perspective view of the dumping cart showing the cart empty and ready to receive a subsequent load.

### DETAILED DESCRIPTION OF THE PREFERRED EMBODIMENT

Referring now to the Figures, a dumping cart 10, configured in accordance with the principles of the present invention, comprises a carriage 12 having first and second rails 13 and 14 joined by cross members 15 at a rear portion 17 of the carriage and joined adjacent to a horizontal axle 20 at a front portion 22 of the carriage.

A front wheel 30 is mounted on the fixed horizontal axle 20, while rear wheels 32 and 34 mounted on vertically pivots 36 and 38. This allows the rear wheels 32 and 34 to pivot about vertical axes 40 and 42 as the wheels roll on horizontal axes 44 and 46. A frame 50 is mounted on the carriage 12 and comprises a pair of vertically extending front struts 52 and 54 and a pair of rear vertically extending rear struts 56 and 58 joined by a pair of upper rails 60 and 62. A front cross brace 66 and a rear cross brace 68 provide a substantially rectangular frame structure for supporting a tray 70. The tray 70 is also referred in the art as a bucket or pan and is preferably a convex, open top container which receives a load 72 which is transported by the dumping cart 10.

The tray 70 has a front end 74 which is pivoted on an axle 76 adjacent to the front brace 66 of the frame 50. The rear portion 78 of the tray 70 rests on the frame 50 adjacent to the rear brace 68 so that the tray can pivot about the horizontal axis 76 to dump the toad 72.

Dumping the load 72 is accomplished by a pair of levers 80 and 82 that are pivoted on a handle support 84 which projects upwardly from the carriage 12 and is attached to the rear portion 17 of the carriage. The handle support 84 is comprised of a pair of vertical struts 85 and 86 which are rigidly attached or otherwise braced at the cross piece 15 of the carriage 12 and which have pivot points 87 and 88 for the levers 80 and 82, respectively. The handle support 84 is rigidified by a handle 89 having grips 90 and 91. The handle 89 is used to maneuver the dumping cart 10 and allows one to push, pull and turn the dumping cart.

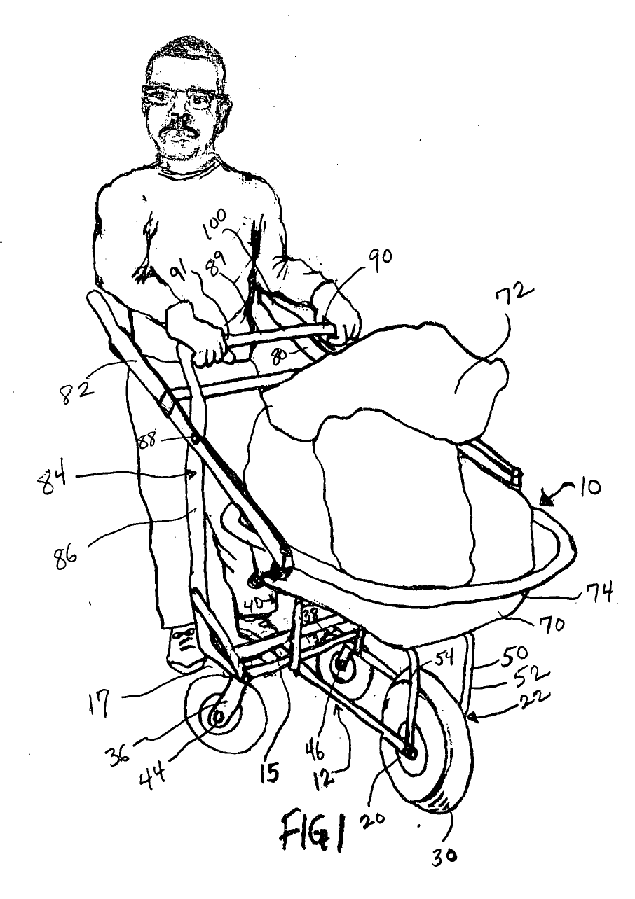

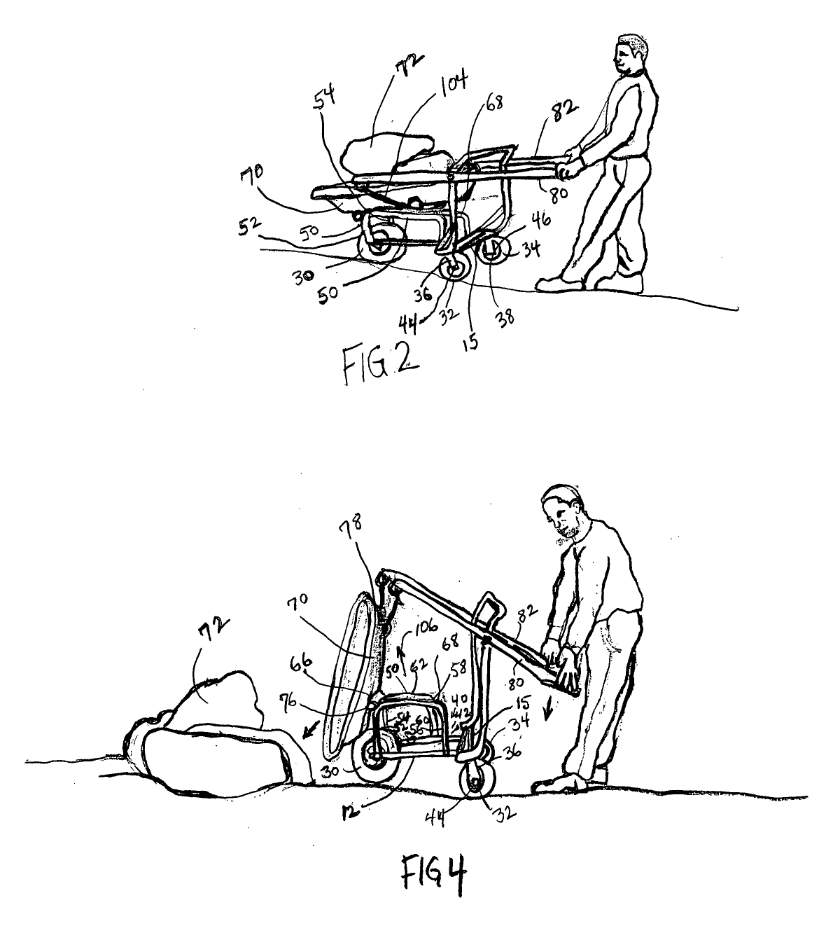

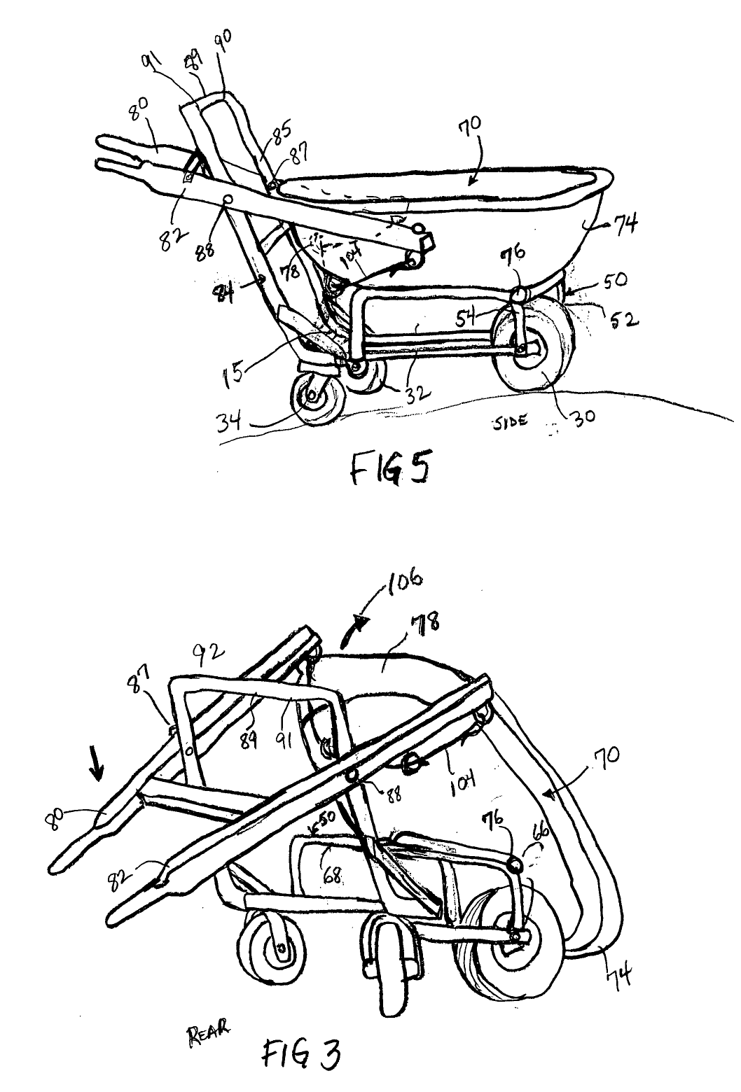

Considering FIGS. 1-4 in sequence, it is seen in FIG. 1 that the cart 10 is being pushed for transport of the load 72 by pushing on the handle 89. As seen in FIG. 2, the user is pushing down on the levers 80 and 82 by pushing on handles 100 and 102 of the levers. When the handles 100 and 102 are pushed, a flexible cable 104, preferably of stainless steel and coupled to the handles, is pressed against the bottom of the tray 70. As seen in FIG. 3, as the user continues to push down on the handles 100 and 102, the levers 80 and 82 lift the flexible cable 104 which extends under the bottom of the tray 70, causing the tray to pivot about the horizontal axis 66 of the axle 76 and rotate clockwise in the direction of arrow 106. Finally, as seen in FIG. 4, the load 72 discharges from the tray 70 as the levers 80 and 82 lift the rear portion 78 of the tray toward a vertical position. The person using the dumping cart 10 then pulls the cart rearwardly a short distance until the tray 70 clears the load 72. The tray 70 then returns to the FIG. 5 position where the rear portion 78 of the tray 70 rest on the frame 50. The dumping cart 10 is then ready to receive a new load 72 as is seen in FIG. 1.

From the foregoing description, one skilled in the art can easily ascertain the essential characteristics of this invention, and without departing form the spirit and scope thereof, can make various changes and modifications of the invention to adapt it to various usages and conditions.

1. A dumping cart comprising:
a carriage;
at least one front wheel on the carriage;
a rear support on the carriage for engaging the ground surface behind the front wheel;
a frame on the carriage;
a tray pivoted on the frame at a location adjacent the front wheel;
a handle support extending above the frame;
a lever arrangement pivoted to the rear support, the lever arrangement extending rearward of the tray and having a second end adjacent the tray, and
a linkage between the second end of the lever arrangement and a rear portion of the tray, wherein rotation of the lever assembly pivots the pan to dump the load forward of the front wheel.

2. The dumping cart of claim 1 wherein the linkage between the lever assembly and the tray comprises a flexible cable arrangement.

3. The dumping cart of claim 1 wherein the first rear support comprises at least one wheel and the second rear support includes a handle for pushing, pulling and steering the dumping cart.

4. The dumping cart of claim 3 wherein the at least one rear wheel is mounted to the carriage by a vertical pivot.

5. The dumping cart of claim 4 wherein there are two laterally spaced rear wheels each of which is mounted to the carriage by a vertical pivot and wherein there is a single front wheel.

6. The dumping cart of claim 5 wherein the linkage between the lever assembly and the tray comprises a flexible cable arrangement.

7. The dumping cart of claim 6 wherein the lever arrangement comprises a pair of levers with each lever having a handle at the first end and with each lever having a coupling at the second end, with the flexible cable arrangement being attached at opposite ends to second ends of the levers.

8. A dumping cart comprising:
a carriage;
a front wheel mounted to rotate on a horizontal axis with respect to the carriage;
a pair of laterally spaced back wheels mounted to turn about horizontal axles supported on vertical pivots attached to the carriage;
a tray mounted on the carriage and having a front portion and a back portion, the tray being pivotal on a horizontal axis with respect to the carriage;
a handle support extending up from the carriage;
a handle attached to the handle support for pushing, pulling and steering the dumping cart;
a pair of levers pivoted to the handle support, the levers each having first and second ends, wherein the first ends of the levers provide handles for pivoting the levers relative to the handle support and the second ends have couplings thereon adjacent the rear portions of the tray, and
a linkage attaching the couplings at the second ends of the levers to the rear portions of the tray to lift the tray upon pushing down on the first ends of the levers.

9. The dumping cart of claim 8 wherein the linkage is a flexible cable arrangement attached at opposite ends to the couplings on the second ends of the levers.

10. The dumping cart of claim 9 further including a frame for supporting the tray in vertical spaced relation on the carriage.
